(19) United States
(12) Patent Application Publication
(10) Pub. No.: US 2005/0140135 A1
(43) Pub. Date: Jun. 30, 2005

(54) Label with clear adhesive portion

(76) Inventors: Richard T. Miller, Pittsburgh, PA (US); Robert S. Snyder, Glenshaw, PA (US)

Correspondence Address: THORP REED & ARMSTRONG, LLP, ONE OXFORD CENTRE, 301 GRANT STREET, 14TH FLOOR, PITTSBURGH, PA, 15219-1425, US

(21) Appl. No.: 11/003,895

(22) Filed: Dec. 3, 2004

Related U.S. Application Data
(60) Provisional application No. 60/527,433, filed on Dec. 5, 2003.

(51) Int. Cl. B42D 15/00

(52) U.S. Cl. 283/81

(57) ABSTRACT

One aspect of the present invention relates to a label comprising both an adhesive portion and a non-adhesive portion. The adhesive portion of the label may be transparent so as not to occlude any pre-existing information on a manufacturer-supplied package once applied to the manufacturer's package. The non-adhesive portion of the label may contain bar-coded information, as well as human readable text, and may protrude from the product for the purposes of applying the bar-coded information to a previously non-bar-coded product. The label may be flexible, thus allowing the folding or rolling of the non-adhesive portion for the purposes of decreasing the storage space required for the manufacturer product that has had the new label attached and allowing the adhesive portion to conform to the product to which it is attached. Because of the rules governing abstracts, this abstract should not be used to construe the claims.

### CROSS REFERENCE TO RELATED APPLICATIONS

This application claims priority from provisional application Ser. No. 60/527,433 filed 5 Dec. 2003 and entitled Label With Clear Adhesive Portion, the entirety of which is hereby incorporated by reference.

### BACKGROUND OF THE INVENTION

The present invention relates generally to labels and more particularly to the application of a label to a manufacturer's product without obscuring any pre-existing manufacturer information.

Product packaging supplied by a manufacturer typically includes some pre-existing information printed thereon. However, this packaging may often lack the specific labeling required by a purchaser. For example, most vials, ampoules and syringes used in the healthcare setting may include manufacturer information (e.g., the name of the drug contained in the vial, the expiration date, etc.) printed on the packaging, but may not include a bar code label required by a specific hospital. The bar codes may be necessary for the hospital to implement a point of care system. Thus, the hospital is required to place bar codes on these items to utilize the bedside point of care systems.

In certain situations, the application of a label by a purchaser may present certain problems. For example, due to the size of the product and the size of the label being applied, pre-existing manufacturer information printed on the product may undesirably be obscured when the purchaser applies another label.

As an alternative to placing a label directly on the product, a purchaser may place the product in a secondary container (e.g., a bag). The secondary container may then be labeled. This use of a secondary container, however, may increase the cost associated with labeling the product and may prevent the product from being dispensed from existing dispensing systems.

Thus, there exists a need for a label which can be applied to a manufacture's product by a purchaser without obscuring pre-existing manufacturer information and that overcomes the other limitations inherent in prior art.

### SUMMARY OF THE INVENTION

One aspect of the present invention relates to a label for odd forms of medications comprising a non-adhesive portion having a human readable section and a machine readable section, and a transparent adhesive portion.

Another aspect of the present invention relates to a method of applying a label having a transparent adhesive portion and a non-adhesive portion to manufacturer's product. The method comprises printing at least one of user readable information or machine readable information on the non-adhesive portion, and attaching the transparent adhesive portion to the manufacturer's product.

### BRIEF DESCRIPTION OF THE DRAWINGS

To enable the present invention to be easily understood and readily practiced, the present invention will now be described for purposes of illustration and not limitation, in connection with the following figures wherein:

FIG. 1 illustrates a perspective view of a label according to one embodiment.

FIG. 2 illustrates an exploded view of a portion of the label of FIG. 1 according to one embodiment.

FIG. 3 illustrates a simplified view of a manufacturer-supplied product package according to one embodiment.

FIG. 4 illustrates the manufacturer-supplied product package of FIG. 3 with the label of FIG. 1 attached thereto according to one embodiment.

### DETAILED DESCRIPTION OF THE INVENTION

The label 10 of the present invention is described in conjunction with producing labels for odd forms of medications in a healthcare setting. “Odd forms of medications” refers to, among others, medical items and supplies that cannot be packaged into unit dose packages (for example, vials, ampoules, syringes, etc.). It should be apparent to one skilled in the art, however, that the label 10 may be used for a multitude of other applications while remaining within the scope of the present invention. It should further be apparent to one skilled in the art that the instant discussion is provided for exemplary purposes only and is in no way intended to limit the scope of the present invention.

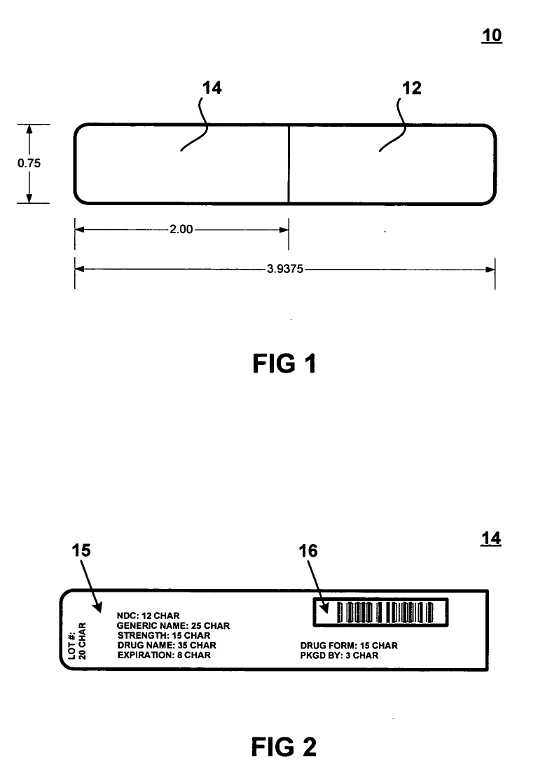

FIG. 1 illustrates a perspective view of a label 10 according to an embodiment. The label 10 is comprised of two portions, a non-adhesive portion 14 and an adhesive portion 12. FIG. 2 illustrates an exploded view of the non-adhesive portion 14 of the label 10 of FIG. 1 according to one embodiment.

In the current embodiment, the non-adhesive portion 14 is comprised of a human readable section 15 which may include an NDC field, a generic name field, a strength field, a drug name field, an expiration date field, a drug form field, a packaged by field, and a lot number field, among others. The non-adhesive portion 14 may also include a machine readable section 16, for example, comprised of an EAN/UCC compliant bar code. It should be noted that the number and type of indicia contained on the label 10 may be varied while remaining within the scope of the present invention. In the current embodiment, the non-adhesive portion 14 of the label 10 is flexible, thus allowing the folding or rolling of the non-adhesive portion 14 for the purposes of decreasing the storage space required for the manufacturer product that has had the new label 10 attached.

The adhesive portion 12 is comprised of a transparent material having a permanent adhesive on one side thereof to facilitate attaching the label 10 to a product. The adhesive portion 12 of the label 10 may also be flexible, thus allowing the adhesive portion 12 to conform to the shape of the package to which it is applied (e.g., to a vial, bottle, syringe, etc.).

In the current embodiment, the label 10 is approximately 3.9375 inches (100 mm) by 0.75 inches (19.05 mm). The non-adhesive portion 14 is 2.0 inches (50.8 mm) by 0.75 inches (19.05 mm) and the adhesive portion 12 is 1.9375 inches (49.21 mm) by 0.75 inches (19.05 mm). The label 10 is made from clear polypropylene with a thickness of two mils (0.0508 mm). The non-adhesive portion 14 is double block white “side”, triple “bump” white with varnish as is know in the art. The adhesive portion 12 has AP151 permanent adhesive applied to one side thereof.

In the current embodiment, machine readable section of the non-adhesive portion 14 includes an EAN/UCC compliant bar code 16 which may include the national drug code (NDC) number and the expiration date of the product. The bar code 16 is 1.25 inches (31.75 mm) by 0.25 inches (6.35 mm) in size. The human readable section 15 includes an NDC field containing 12 characters, a generic name field containing 25 characters, a strength field containing 15 characters, a drug name field containing 35 characters, an expiration date field containing 8 characters, a drug form containing 15 characters, a packaged by field containing 3 characters, and a lot number field containing 10 characters.

It should be noted that the above-described dimensions and field character lengths are exemplary only and that other dimensions and field character lengths may be used while remaining within the scope of the present invention.

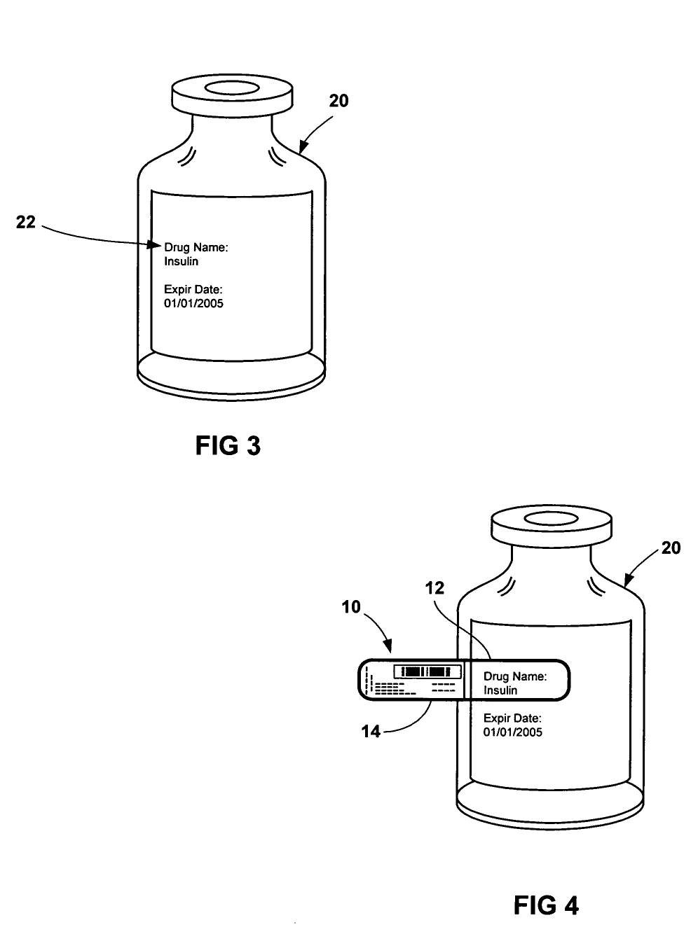

FIG. 3 illustrates a simplified view of a manufacturer-supplied product package 20 (e.g., a vial) according to one embodiment. The vial 20 has pre-existing information 22 (i.e., the drug name and drug expiration date) printed thereon.

FIG. 4 illustrates the manufacturer-supplied product package 20 of FIG. 3 with the label 10 of FIG. 1 attached thereto. In the current embodiment, the user readable information and/or machine readable information is printed on the non-adhesive portion using a label printer (not shown) prior to attaching the label 10 to the manufacturer-supplied product package 20. As discussed above, the user readable information may include an NDC field, a generic name field, a strength field, a drug name field, an expiration date field, a drug form field, a packaged by field, and/or a lot number field (among others), whereas the machine readable information may include a bar code (among others) that can be recognized by a bedside point of care system.

The transparent adhesive portion 12 is then attached to the manufacturer's product package 20 by placing the adhesive on the adhesive portion 12 of the label 10 in contact with the product package 20. Because the adhesive portion 12 is made from a transparent material, the label 10 will not obscure pre-existing manufacture information 22 printed on the product package 20. Thus, the label 10 may be applied anywhere on the product package 20 while still allowing the purchaser to utilize the pre-existing manufacturer's information 22. At the same time, the label 10 provides a bar code 16 that will be recognized by bedside point of care systems and includes human readable text 15 for the purposes of pharmacist validation of the repackaged product prior to leaving the pharmacy. Additionally, the barcode 16 will support point of care scanning of the product at a patient's bedside prior to administration of the product to improve patient safety.

In the current embodiment, the non-adhesive portion 14 of the label 10 may be rolled or folded to reduce the amount of space required for storing the manufacturer product package 20 after the label 10 has been attached. For example, the non-adhesive portion may be rolled to match the contour of the outside of the manufacturer product package 20.

It should be recognized by one skilled in the art that the label 10 may be adapted to be printed by a variety of printer types. For example, labels 10 may be adapted to be individually fed through a printer, may be adapted to be supplied on a roll for continuous feed through the printer, or may be adapted to be fed in a sheet through the printer such that multiple labels may be simultaneously printed, among others.

It should further be recognized that the above-described embodiments of the invention are intended to be illustrative only. Numerous alternative embodiments may be devised by those skilled in the art without departing from the scope of the following claim.

1. A label for odd forms of medications, comprising:
a non-adhesive portion having a human readable section and a machine readable section; and
a transparent adhesive portion.

2. The label of claim 1 wherein said human readable section includes printed thereon at least one of an NDC field, a generic name field, a strength field, a drug name field, an expiration date field, a drug form field, a packaged by field, or a lot number field.

3. The label of claim 1 wherein said machine readable section includes a bar code.

4. The label of claim 1 wherein said machine readable section can be recognized by a bedside point of care system.

5. The label of claim 1 wherein at least one of said non-adhesive portion and said adhesive portion is flexible.

6. The label of claim 1 wherein said label is made from polypropylene.

7. The label of claim 1 wherein said label is approximately 3.975 inches (100 mm) long, 0.75 inches (19.03 mm) wide, and 2 mils (0.0508 mm) thick.

8. The label of claim 1 wherein said non-adhesive portion is double block white side, triple bump white with varnish.

9. The label of claim 1 wherein said adhesive portion has AP51 permanent adhesive applied to one side thereof.

10. A method of applying a label having a transparent adhesive portion and a non-adhesive portion to manufacturer's product, said method comprising:
printing at least one of user readable information or machine readable information on said non-adhesive portion; and
attaching said transparent adhesive portion to said manufacturer's product.

11. The method of claim 10 wherein said printing user readable information on said non-adhesive portion includes printing at least one of an NDC field, a generic name field, a strength field, a drug name field, an expiration date field, a drug form field, a packaged by field, and a lot number field.

12. The method of claim 10 wherein said printing machine readable information on said non-adhesive portion includes printing a bar code.

13. The method of claim 10 wherein said attaching said transparent adhesive portion includes adhering said transparent adhesive portion over pre-existing information on said manufacturer's product without obscuring said pre-existing information.

14. The method of claim 10 further comprising folding said non-adhesive portion of said label.

15. The method of claim 10 further comprising rolling said non-adhesive portion of said label.
